(19) United States
(12) Patent Application Publication
(10) Pub. No.: US 2007/0156712 A1
(43) Pub. Date: Jul. 5, 2007

(54) Semantic grammar and engine framework

(76) Inventors: Brian J. Wasserman, Escondido, CA (US); Thomas K. Ryan, Valley Center, CA (US)

Correspondence Address: JAMES M. STOVER;NCR CORPORATION, 1700 SOUTH PATTERSON BLVD, WHQ4, DAYTON, OH, 45479, US

(21) Appl. No.: 11/319,672

(22) Filed: Dec. 28, 2005

(51) Int. Cl. G06F 7/00

(52) U.S. Cl. 707/100

(57) ABSTRACT

A Semantic Engine Framework comprises a computer-implemented system for the implementation and execution of a plurality of Semantic Algorithms, Semantic Rules and Semantic Properties. Semantic Algorithms perform Semantic Rules in order to apply Semantic Properties to database tables and columns. Semantic Properties involve the labeling of specific tables or columns in a way that the labels are meaningful to a specific application.

### BACKGROUND OF THE INVENTION

1. Field of the Invention

This invention relates in general to database management systems, and specifically, to a computer-implemented system for assigning semantic labels to tables and columns in a database management system.

2. Description of Related Art

When implementing a sophisticated analytical application, a data discovery process is typically employed. The data discovery process is a manual, time intensive process in which a developer attempts to identify the required data elements in the database.

Semantic algorithms may be used in an attempt to speed up this process. Semantic algorithms are programmatic computer algorithms that apply a set of semantic rules to automatically identify the correct tables and columns in a database required by the analytic application. Semantic properties can then be used to label the tables and columns required by the analytic application, and if correctly applied, represent a significant improvement to the data discovery process.

However, there are multiple ways in which semantic properties can be applied to a database, as represented by different semantic algorithms. For example, one algorithm could use a scoring process to test a series of rules against the tables and columns, and apply the semantic properties to a database entity with the highest score. Another algorithm may apply a set of probability rules. Each algorithm has merits, and may be more accurate in certain circumstances; however, implementing two (or more) separate semantic algorithms is a very time consuming process.

What is needed in the art is an improved method for implementing semantic algorithms. Specifically, there is a need in the art for a method that allows implementation of a semantic algorithm by providing many of the core components required by all semantic algorithms, and by providing a framework in which a semantic algorithm can be implemented. The present invention satisfies that need.

### SUMMARY OF THE INVENTION

A Semantic Engine Framework comprises a computer-implemented system for the implementation and execution of a plurality of Semantic Algorithms, Semantic Rules and Semantic Properties. Semantic Algorithms perform Semantic Rules in order to apply Semantic Properties to database tables and columns. Semantic Properties involve the labeling of specific tables or columns in a way that the labels are meaningful to a specific application.

The Semantic Engine Framework includes:
A Semantic Engine, which executes a Semantic Algorithm to perform a set of Semantic Rules that apply a Semantic Property.
A Semantic Grammar, which is a common methodology for representing Semantic Rules and Semantic Properties in an XML format
An object-oriented framework for specifying the Semantic Algorithm.

This invention allows a user to implement Semantic Algorithms for performing Semantic Rules that apply Semantic Properties in a very rapid manner, while reusing portions of previous implementations. This invention is a significant improvement to the process of creating and implementing Semantic Algorithms, Semantic Rules and Semantic Properties.

### BRIEF DESCRIPTION OF THE DRAWINGS

Referring now to the drawings in which like reference numbers represent corresponding parts throughout:

FIG. 1 illustrates an exemplary hardware and software environment according to the preferred embodiment of the present invention;

FIG. 2 is a block diagram that illustrates the class specifications for the Semantic Algorithms, Semantic Properties and Semantic Rules according to the preferred embodiment of the present invention;

FIG. 3 is a flowchart that illustrates the steps performed by the Semantic Engine according to the preferred embodiment of the present invention; and

FIG. 4 is a flowchart that illustrates the steps performed by the Semantic Algorithm according to the preferred embodiment of the present invention.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Overview

A Semantic Engine Framework is a framework in which Semantic Algorithms, Semantic Rules and Semantic Properties can be implemented and executed. Semantic Algorithms perform Semantic Rules that assign Semantic Properties to database tables and columns. Semantic Properties involve labeling specific tables or columns in a way that the labels are meaningful to a specific application.

Hardware and Software Environment

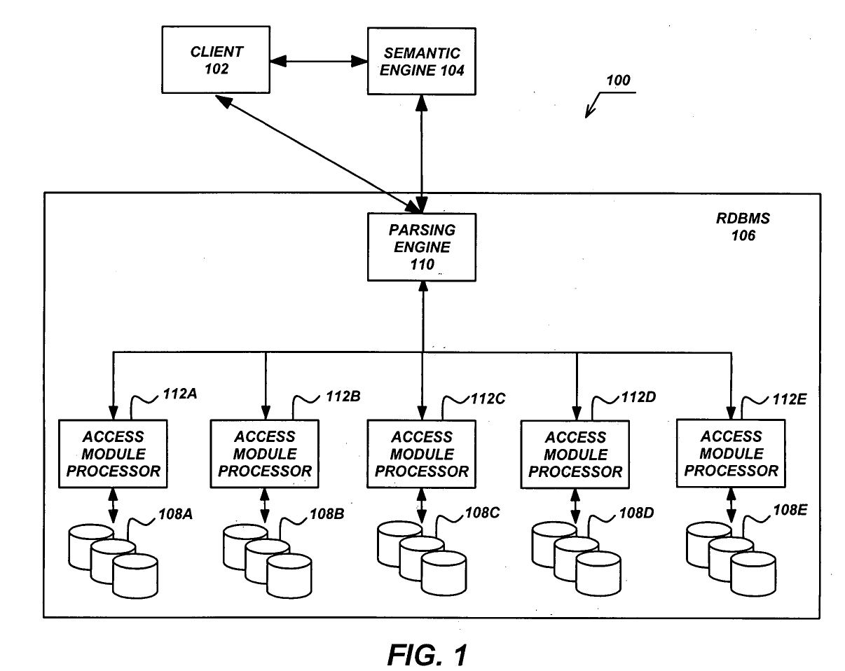

FIG. 1 illustrates an exemplary hardware and software environment according to the preferred embodiment of the present invention. In the exemplary environment, a computer system 100 implements a database processing system, known as the Semantic Engine Framework, in a three-tier client-server architecture, wherein the first or client tier provides a Client 102 that may include, inter alia, a graphical user interface (GUI), the second or middle tier provides a Semantic Engine 104 for performing functions as described later in this application, and the third or server tier comprises a Relational DataBase Management System (RDBMS) 106 that stores data and metadata in a relational database 108A-E. The first, second, and third tiers may be implemented in separate machines, or may be implemented as separate or related processes in a single machine.

In the preferred embodiment, the RDBMS 106 includes at least one Parsing Engine (PE) 110 and one or more Access Module Processors (AMPs) 112A-112E storing the relational database 108. The Parsing Engine 110 and Access Module Processors 112 may be implemented in separate machines, or may be implemented as separate or related processes in a single machine. The RDBMS 106 used in the preferred embodiment comprises the Teradata® RDBMS sold by NCR Corporation, the assignee of the present invention, although other DBMS's could be used.

Generally, the Client 102 includes a graphical user interface (GUI) for operators of the system 100, wherein requests are transmitted to the Semantic Engine 104 and/or the RDBMS 106, and responses are received therefrom. In response to the requests, the Semantic Engine 104 performs the functions described below, including formulating queries for the RDBMS 106 and processing data retrieved from the RDBMS 106. Moreover, the results from the functions performed by the Semantic Engine 104 may be provided directly to the Client 102 or may be provided to the RDBMS 106 for storing into the relational database 108. Once stored in the relational database 108, the results from the functions performed by the Semantic Engine 104 may be independently retrieved from the RDBMS 106 by the Client 102.

Note that the Client 102, the Semantic Engine 104, and the RDBMS 106 may be implemented in separate machines, or may be implemented as separate or related processes in a single machine. For example, the system may comprise a two-tier client-server architecture, wherein the client tier includes both the Client 102 and the Semantic Engine 104.

Moreover, in the preferred embodiment, the system 100 may use any number of different parallelism mechanisms to take advantage of the parallelism offered by the multiple tier architecture, the client-server structure of the Client 102, Semantic Engine 104, and RDBMS 106, and the multiple Access Module Processors 112 of the RDBMS 106. Further, data within the relational database 108 may be partitioned across multiple data storage devices to provide additional parallelism.

Generally, the Client 102, Semantic Engine 104, RDBMS 106, Parsing Engine 110, and/or Access Module Processors 112A-112E comprise logic and/or data tangibly embodied in and/or accessible from a device, media, carrier, or signal, such as RAM, ROM, one or more of the data storage devices, and/or a remote system or device communicating with the computer system 100 via one or more data communications devices.

However, those skilled in the art will recognize that the exemplary environment illustrated in FIG. 1 is not intended to limit the present invention. Indeed, those skilled in the art will recognize that other alternative environments may be used without departing from the scope of the present invention. In addition, it should be understood that the present invention may also apply to components other than those disclosed herein.

Semantic Engine Framework

The Semantic Engine Framework of the present invention is intended as a framework in which one or more Semantic Algorithms can be implemented and executed that perform one or more Semantic Rules in order to assign one or more Semantic Properties to database 108 tables and columns based on the information contained in the database 108 metadata. This framework generalizes the overall approach to semantics to accommodate any number and type of Semantic Algorithm, Semantic Rule or Semantic Property. Moreover, this framework is also designed so that it can be easily maintained and extended to meet future requirements.

For example, a specific application may need to identify a table that holds Call Detail Records. The Semantic Engine Framework endeavors to automatically apply (without human intervention) a Semantic Property comprising a label of “Call Detail Record” to the correct table based on a set of Semantic Rules.

The Semantic Engine Framework is designed to handle all of the common work involved in assigning semantics. This includes reading and writing database 108 metadata, as well as Semantic Rule files, and assigning Semantic Properties to the database 108 metadata. This framework is also designed to run with multiple Semantic Algorithms. Finally, the framework includes several common classes that represent Semantic Rules and Semantic Properties. These classes can be extended as necessary to support specific Semantic Algorithms.

Relational Database Metadata

Metadata, literally “data about data,” is information that describes another set of data. The Semantic Engine Framework uses an XML file to store the database 108 metadata. Examples of this metadata may include:
a table storing metadata for all tables in the database 108, including their names, sizes, the number of rows in each table and the number of columns in each table;
a table storing metadata for all columns in the database 108, including their names, the type of data stored in the column, and what tables they are used in.

In alternative embodiments, the relational database 108 may use tables to store the metadata used by the Semantic Engine Framework.

Semantic Grammar

The Semantic Grammar is a common grammar for expressing a set of Semantic Properties, and a set of Semantic Rules that are used to apply the Semantic Properties. Semantic Properties are labels that are applied to database 108 tables and/or columns. Semantic Rules are the rules used for applying these labels. One or more Semantic Properties are applied via a set of one or more Semantic Rules performed by one or more Semantic Algorithms executed by the Semantic Engine.

While there are different Semantic Algorithms that can be used to assign Semantic Properties based on a set of Semantic Rules, this invention creates a common and reusable methodology for representing these Semantic Properties and Semantic Rules. The Semantic Grammar represents a significant improvement to the process of defining Semantic Properties and Semantic Rules in an easily readable manner, and provides a common grammar for multiple different Semantic Algorithms.

Semantic Properties and Rules

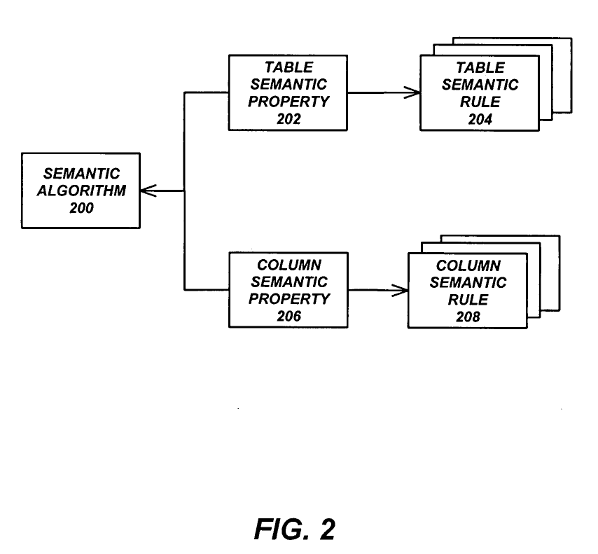

FIG. 2 is a block diagram that illustrates the class specifications for the Semantic Algorithms, Semantic Properties and Semantic Rules according to the preferred embodiment of the present invention.

Semantic Algorithms 200 assign Table Semantic Properties 202 using associated Table Semantic Rules 204, as well as Column Semantic Properties 206 using associated Column Semantic Rules 208. Semantic Rules 204, 208 are facts that help identify the table or column that corresponds to a Semantic Property 202, 206. Semantic Rules 204, 208 tend to be exclusive and additive, meaning that as more rules test “true” for a table or column, the higher the overall score will be for that table or column.

Table Semantic Properties and Rules

As noted above, a Table Semantic Property 202 is typically a user-specified label, wherein any number of Table Semantic Rules 204 may be associated with that Table Semantic Property 202, and the Table Semantic Rules 204 determine which table should be assigned the Table Semantic Property 202. The following describes an exemplary set of Table Semantic Rules 204 that may be used with a Table Semantic Property 202:
Tablename IS<str>: A rule that checks for table name matches.
Tablename CONTAINS <str>: A rule that checks for table names that contain a specified string (substring).
1 to M relationship to a specified Table Property: A rule that checks that potential table candidates for the Table Semantic Property have a one to many relationship with a potential table candidate for a specified table property.
M to 1 relationship to a specified Table Property: A rule that checks that potential table candidates for the Table Semantic Property have a many to one relationship with a potential table candidate for a specified table property.
Join Cardinality (optional in 1 to M and M to 1 rules): A rule that checks for a specific join cardinality (in addition to checking for 1 to Many or Many to 1 relationships).
Has Columns that CONTAIN <str>: A rule that determines whether the table has columns that contain a specified string (substring).
Rowcount: A rule that determines whether the number of rows in a table is greater-than or less-than a user-specified value.
Columncount: A rule that determines whether the number of columns in a table is greater-than or less-than a user-specified value.
Has Many/Few Rows: A rule that determines whether the number of rows in a column is “many” or “few.”
Has Many/Few Columns: A rule that determines whether the number of columns in a table is “many” or “few.”
Table CONTAINS Column Semantic Property: A rule that determines whether a table candidate for the Table Semantic Property contains the column candidates of the specified Column Semantic Property.

Of course, other Table Semantic Rules 204 may be developed, implemented and executed within the context of the present invention, and the above list of Table Semantic Rules 204 is not meant to be exhaustive.

Column Semantic Properties and Rules

As noted above, a Column Semantic Property 206 is typically a user-specified label. Any number of Column Semantic Rules 208 may be associated with that Column Semantic Property 206, wherein the Column Semantic Rules 208 determine which column should be assigned the Column Semantic Property 206. The following describes an exemplary set of Column Semantic Rules 208 that may be used with a Column Semantic Property 206:
Column Name IS<str>: A rule that checks for string matches in the name of each column.
Column Name CONTAINS <str>: A rule that checks whether column names contain a specified string.
Column Datatype=<enumerated datatype>: A rule that checks the datatype of each column.
Distinct Value Count: A rule that determines whether the number of distinct values in a column is greater-than or less-than a user-specified value.
Has Many/Few Distinct Values: A rule that determines whether the columns have “many” or “few” distinct values.
Column is primary key: A rule that determines whether a column is a primary key.
Column is foreign key: A rule that determines whether a column is a foreign key.

Of course, other Column Semantic Rules 208 may be developed, implemented and executed within the context of the present invention, and the above list of Column Semantic Rules 208 is not meant to be exhaustive.

Semantic Engine

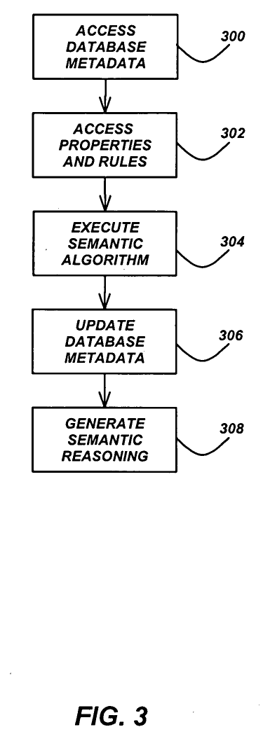

FIG. 3 is a flowchart that illustrates the steps performed by the Semantic Engine 104 according to the preferred embodiment of the present invention.

The Semantic Engine 104 executes one or more Semantic Algorithms 200 that perform one or more Semantic Rules 204, 208 to apply one or more Semantic Properties 202, 206 to tables and columns in the database 108. The functions performed by the Semantic Engine 104 include the following:

Block 300 represents the Semantic Engine 104 accessing the database 108 metadata.

Block 302 represents the Semantic Engine 104 accessing the Semantic Properties 202, 206 and Semantic Rules 204, 208.

Block 304 represents the Semantic Engine 104 executing an appropriate Semantic Algorithm 200 that performs the Semantic Rules 204, 208 to apply the Semantic Properties 202, 206 to the database 108 tables and columns using the database 108 metadata. Specifically, the Semantic Algorithm 200 executed by the Semantic Engine 104 loops through table and column properties found in the database 108 metadata, and performs the set of Semantic Rules 204, 208, which results in the application or assignment of the Semantic Properties 202, 206 to the database 108 tables and columns.

Block 306 represents the Semantic Engine 104 updating the table and column properties found in the database 108 metadata with the results of Block 304. Specifically, the database 108 metadata now reflects the Semantic Properties 202, 206 assigned to the database 108 tables and columns by the Semantic Rules 204, 208.

Block 308 represents the Semantic Engine 104 generating semantic reasoning information.

Semantic Algorithm

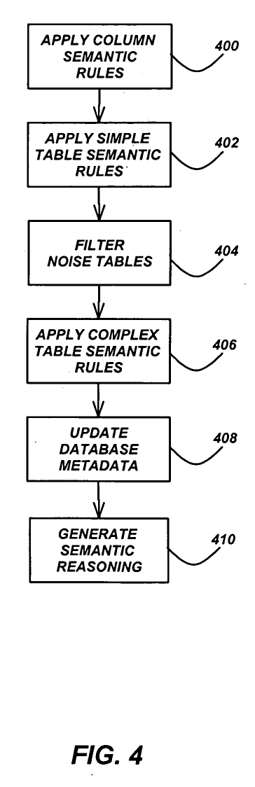

FIG. 4 is a flowchart that illustrates the steps performed by the Semantic Algorithm 200 according to the preferred embodiment of the present invention.

Block 400 represents the Semantic Algorithm 200 performing all Column Semantic Rules 208 on each database 108 column, and then assigning the Column Semantic Property 206 to the best candidate(s).

Block 400 represents the Semantic Algorithm 200 performing all simple Table Semantic Rules 204 on each database 108 table. Simple Table Semantic Rules 204 include name tests, table name and column substring tests, and row count and/or column count tests.

Block 400 represents the Semantic Algorithm 200 filtering the resulting table candidates to remove “noise” tables. Many of the Table Semantic Rules 204 are very general, meaning they test “true” for a large number of tables. For example, many tables may have columns containing the strings “id” for identifier or “dt” for date. Tables that have a low score after the simple Table Semantic Rules 204 are tested are most likely noise tables that can be eliminated from further consideration. The goal in this step is to pass on only the most viable table candidates for the complex Table Semantic Rules 204, which are more effective if the tables have first been filtered.

Block 400 represents the Semantic Algorithm 200 performing the complex Table Semantic Rules 204 on each database 108 table, and then assigning the Table Semantic Property 202 to the best candidate(s). These complex Table Semantic Rules 204 include: 1 to many, and many to 1 with the optional join cardinality, and tests to determine whether a table candidate contains a previously-assigned Column Semantic Property 206.

Block 400 represents the Semantic Algorithm 200 generating the semantic reasoning information resulting from the Semantic Rules 204, 208.

Scoring Algorithm

In one embodiment, the Semantic Algorithm 200 is a scoring algorithm that assigns weights to one or more of the Semantic Rules 204, 208, and then uses these weights to assign Semantic Properties 202, 206 to database 108 tables and columns.

The purpose of weighting the Semantic Rules 204, 208 is to allow some Semantic Rules 204, 208 to have more importance than other Semantic Rules 204, 208. Name rules, for example, can be used to quickly identify specific tables or columns.

Consider, for example, a scoring algorithm that uses the following three weights:
HIGH—50 points
MEDIUM—10 points
LOW—5 points

Scoring is done by testing all of the Semantic Rules 204, 208 for each Semantic Property 202, 206 against all database 108 tables and columns. Points are assigned for each successful Semantic Rule 204, 208 test, and the point value is determined by the weighting of the Semantic Rule 204, 208.

For example, every time a HIGH weighted Semantic Rule 204, 208 is found to be true, that table or column would receive 50 points, as compared to 10 for a MEDIUM weighted Semantic Rule 204, 208, or 5 points for a LOW weighted Semantic Rule 204, 208.

Once all Semantic Rules 204, 208 have been tested against all database 108 tables and columns, the table or column with the highest “score” for a specific Semantic Property 202, 206 is assigned that Semantic Property 202, 206.

Default weightings for all types of Semantic Rules 204, 208 may be built into the scoring algorithm. Thus, users are not required to assign a weight to every single Semantic Rule 204, 208, however, they can selectively override the weightings of particular Semantic Rules 204, 208.

The following table shows exemplary default HIGH/MEDIUM/LOW weightings of the Table Semantic Rules 204:

| Table Semantic Rule | Weight |
|---|---|
| Tablename IS <str> | HIGH |
| Tablename CONTAINS <str> | MEDIUM |
| 1 to M <Table Property> | MEDIUM |
| M to 1 <Table Property> | MEDIUM |
| Join Cardinality (optional, tested only when | HIGH |
| present and when 1 to M or M to 1 test | |
| passes) | |
| Has Columns that Contain <str> | LOW |
| Rowcount <=/>= <num> | MEDIUM |
| Colcount <=/>= <num> | MEDIUM |
| Has Many/Few rows | LOW |
| Has Many/Few cols | LOW |
| Contains Col <Column Property> | HIGH |

The following table shows exemplary default HIGH/MEDIUM/LOW weightings of the Column Semantic Rules 208:

| Column Semantic Rule | Weight |
|---|---|
| Column name IS <str> | HIGH |
| Column name CONTAINS <str> | MEDIUM |
| Column Datatype | LOW |
| Column Distinct Values >=/<= <num> | MEDIUM |
| Column Has Many/Few Distinct Values | LOW |
| Column Is Primary Key | MEDIUM |
| Column is Foreign Key | MEDIUM |

Thresholds

In one embodiment, in order for a Semantic Property 202, 206 to be assigned, the highest scoring candidate must reach a certain point threshold. This threshold may be designed so that a “true” result from multiple MEDIUM weighted Semantic Rules 204, 208 or a single HIGH weighted Semantic Rule 204, 208 will surpass the threshold.

For example, the following thresholds may be used:

Table Semantic Rules: 50 points

Column Semantic Rules: 30 points

The use of thresholds reduces the possibility that a Semantic Property 202, 206 is assigned based on fairly weak reasoning. Consider that some Semantic Rules 204, 208 have LOW weights because they are broad or fuzzy rules, which may result in the Semantic Rule 204, 208 being “true” for a large number of table or column candidates. For example, a Column Semantic Rule 208 that specifies a datatype of INTEGER will generate lots of potential column candidates. If the remaining Column Semantic Rules 208 do not create a strong candidate (or fail altogether), the Semantic Algorithm 200 could assign the corresponding Column Semantic Property 206 based on fairly weak reasoning. Rather than do this, it preferably to specify that a minimum threshold or minimum score must be met before the Semantic Property 202, 206 is assigned.

Multiplicity

In addition, the assignment of a Semantic Property 202, 206 may be based on a “multiplicity” value for the Semantic Property 202, 206, wherein the multiplicity can be either UNIQUE or MULTIPLE. In this context, UNIQUE means that, under ideal circumstances, only one database 108 table or column will be assigned this Semantic Property 202, 206. However, if there are multiple database 108 tables or columns that have the same highest point value, they will all be assigned the Semantic Property 202, 206. On the other hand, MULTIPLE means that the Table or Column Semantic Property 202, 206 will be assigned to all candidates that have a point value higher than the minimum threshold specified above.

Semantic Reasoning Information

It is usually helpful if semantic reasoning information is provided that explains why the Semantic Rules 204, 208 succeeded or failed. This may include the results of every Semantic Rule 204, 208 test, e.g., the Semantic Rule 204, 208, the Semantic Property 202, 206, and the results of applying the Semantic Rule 204, 208. This is useful in providing feedback in order to calibrate or “tune” the Semantic Rules 204, 208.

Semantic Reasoning Information

The Semantic Grammar and XML structure for expressing Semantic Algorithms, Semantic Properties, and Semantic Rules are set forth below:

The following section describes the XML format for Semantic Algorithm specific parameters:

<Element = SemanticRule>

<ComplexType>

<Sequence>

<element name=“Name” type=string/>
<element name=“Value” type=string/>

</Sequence>

</ComplexType>

</Element>

The following section describes the XML format for Table Semantic Rules:

<Element = TableSemanticRule>

<ComplexType>

<Sequence>

<element name=“PropertyName” type=string/>
<element name=“RuleType” type=integer/>
<element name=“Operand1” type=string/>
<element name=“Operand2” type=string/>
<element name=“Value” type=string/>

</Sequence>

</ComplexType>

</Element>

The following section describes the XML format for Column Semantic Rules:

<Element = ColumnSemanticRule>

<ComplexType>

<Sequence>

<element name=“PropertyName” type=string/>
<element name=“RuleType” type=integer/>
<element name=“Operand1” type=string/>
<element name=“Operand2” type=string/>
<element name=“Value” type=string/>

</Sequence>

</ComplexType>

</Element>

The following section describes the XML format for Table Semantic Properties:

<Element = SemanticProperty>

<ComplexType>

<Sequence>

<element name = “PropertyName” type = string/>
<element name=“PropertyType” type=integer/>
<element name = “PropertyDesc” type = string/>
<element name = “Multiplicity” type= integer/>
<element name = “Role” type = integer/>
<element name = “Priority” type=decimal/>
<element name= “isa” type = string/>

</Sequence>

</ComplexType>
<Element = TableSemanticRule>

<ComplexType>
<Sequence>

<element name=“PropertyName” type=string/>
<element name=“RuleType” type=integer/>
<element name=“Operand1” type=string/>
<element name=“Operand2” type=string/>
<element name=“Value” type=string/>

</Sequence>
</ComplexType>

</Element>

</Element>

The following section describes the XML format for Column Semantic Properties:

<Element = ColumnSemanticProperty>

<ComplexType>

<Sequence>

<element name = “PropertyName” type = string/>
<element name=“PropertyType” type=integer/>
<element name = “PropertyDesc” type = string/>
<element name = “Multiplicity” type= integer/>
<element name = “Role” type = integer/>
<element name = “Priority” type=decimal/>
<element name= “isa” type = string/>

</Sequence>

</ComplexType>
<Element = ColumnSemanticRule>

<ComplexType>

<Sequence>

<element name=“PropertyName” type=string/>
<element name=“RuleType” type=integer/>
<element name=“Operand1” type=string/>
<element name=“Operand2” type=string/>
<element name=“Value” type=string/>

</Sequence>

</ComplexType>

</Element>

</Element>

### CONCLUSION

This concludes the description of the preferred embodiment of the invention. The following paragraphs describe some alternative embodiments for accomplishing the same invention.

In one alternative embodiment, any type of computer or configuration of computers could be used to implement the present invention. In addition, any database management system, analytical application, or other computer program that performs similar functions could be used with the present invention.

In summary, the present invention discloses a Semantic Engine Framework for implementing and executing one or more Semantic Algorithms, Semantic Rules and Semantic Properties, wherein the Semantic Algorithms perform the Semantic Rules in order to apply the Semantic Properties to tables or columns stored in a database.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An apparatus for applying semantic properties to a database, comprising:
(a) a computer;
(b) a Semantic Engine Framework, performed by the computer, for implementing and executing one or more Semantic Algorithms, wherein the Semantic Algorithms perform the Semantic Rules in order to apply the Semantic Properties to tables or columns stored in a database.

2. The apparatus of claim 1, wherein the Semantic Properties comprises labels assigned to the tables or columns in a way that the labels are meaningful to a specific application.

3. The apparatus of claim 1, wherein the Semantic Properties are assigned to the tables or columns based on information contained in the database's metadata.

4. The apparatus of claim 1, wherein the Semantic Rules are facts that identify the table or column that corresponds to the Semantic Property.

5. The apparatus of claim 1, wherein the Semantic Rules are additive.

6. The apparatus of claim 1, wherein any number of Semantic Rules are associated with the Semantic Property, and the Semantic Rules determine which table or column should be assigned the Semantic Property.

7. The apparatus of claim 1, wherein the Semantic Rules comprise one or more rules selected from:
a rule that checks for table name matches,
a rule that checks for table names that contain a specified string,
a rule that checks that potential table candidates for the Semantic Property have a one to many relationship with a potential table candidate for a specified table property,
a rule that checks that potential table candidates for the Semantic Property have a many to one relationship with a potential table candidate for a specified table property,
a rule that checks for a specific join cardinality,
a rule that searches the table for columns that contain a specified string,
a rule that determines whether a number of tows in a table is greater-than or less-than a user-specified value,
a rule that determines whether a number of columns in a table is greater-than or less-than a user-specified value,
a rule that determines whether a number of rows in a column is many or few,
a rule that determines whether a number of columns in a table is many or few, and
a rule that determines whether a table candidate for the Semantic Property contains column candidates of a specified Column Semantic Property.

8. The apparatus of claim 1, wherein the Semantic Rules comprise one or more rules selected from:
a rule that checks for column name matches,
a rule that checks for column names that contain a specified string,
a rule that checks a datatype of each column,
a rule that determines whether a number of distinct values in a column is greater-than or less-than a user-specified value,
a rule that determines whether a number of distinct values in a column is many or few,
a rule that checks whether a column is a primary key, and
a rule that checks whether a column is a foreign key.

9. The apparatus of claim 1, wherein the Semantic Engine performs one or more functions selected from:
accessing the database metadata,
accessing the Semantic Properties and Semantic Rules,
executing the Semantic Algorithm that performs the Semantic Rules to apply the Semantic Properties to the database tables and columns using the database metadata,
updating the table and column properties found in the database metadata to reflect the Semantic Properties assigned to the database tables and columns by the Semantic Rules, and
generating semantic reasoning information.

10. The apparatus of claim 9, wherein the Semantic Algorithm executed by the Semantic Engine loops through table and column properties found in the database metadata, and performs the Semantic Rules, which results in assignment of the Semantic Properties to the database tables and columns.

11. The apparatus of claim 1, wherein the Semantic Algorithm performs one or more functions selected from:
performing all Column Semantic Rules on each database column, and then assigning the Column Semantic Property to the best candidates,
performing simple Table Semantic Rules on each database table to generating resulting tables,
filtering the resulting table candidates to remove noise tables,
performing complex Table Semantic Rules on each database table remaining after the noise tables have been filtered to identify best candidate tables, and then assigning the Table Semantic Property to the best candidates, and
generating semantic reasoning information resulting from the Semantic Rules.

12. The apparatus of claim 11, wherein the simple Table Semantic Rules include name tests, table name and column substring tests, and row count and column count tests.

13. The apparatus of claim 11, wherein the complex Table Semantic Rules include: 1 to many, and many to 1 with the optional join cardinality tests, and tests to determine whether a table candidate contains a previously-assigned Column Semantic Property.

14. The apparatus of claim 11, wherein the semantic reasoning information includes the Semantic Rule, the Semantic Property, and results of applying the Semantic Rule.

15. The apparatus of claim 1, wherein the Semantic Algorithm is a scoring algorithm that assigns weights to one or more of the Semantic Rules, and then uses these weights to assign Semantic Properties to the database tables and columns.

16. The apparatus of claim 15, wherein, in order for the Semantic Property to be assigned, a highest scoring candidate must reach a certain point threshold.

17. The apparatus of claim 1, wherein assignment of a Semantic Property is based on a multiplicity value for the Semantic Property.

18. A method of applying semantic properties to a database, comprising:
performing a Semantic Engine Framework, on a computer, for implementing and executing one or more Semantic Algorithms, wherein the Semantic Algorithms perform the Semantic Rules in order to apply the Semantic Properties to tables or columns stored in a database.

19. The method of claim 18, wherein the Semantic Properties comprises labels assigned to the tables or columns in a way that the labels are meaningful to a specific application.

20. The method of claim 18, wherein the Semantic Properties are assigned to the tables or columns based on information contained in the database's metadata.

21. The method of claim 18, wherein the Semantic Rules are facts that identify the table or column that corresponds to the Semantic Property.

22. The method of claim 18, wherein the Semantic Rules are additive.

23. The method of claim 18, wherein any number of Semantic Rules are associated with the Semantic Property, and the Semantic Rules determine which table or column should be assigned the Semantic Property.

24. The method of claim 18, wherein the Semantic Rules comprise one or more rules selected from:
a rule that checks for table name matches,
a rule that checks for table names that contain a specified string,
a rule that checks that potential table candidates for the Semantic Property have a one to many relationship with a potential table candidate for a specified table property,
a rule that checks that potential table candidates for the Semantic Property have a many to one relationship with a potential table candidate for a specified table property,
a rule that checks for a specific join cardinality,
a rule that searches the table for columns that contain a specified string,
a rule that determines whether a number of rows in a table is greater-than or less-than a user-specified value,
a rule that determines whether a number of columns in a table is greater-than or less-than a user-specified value,
a rule that determines whether a number of tows in a column is many or few,
a rule that determines whether a number of columns in a table is many or few, and
a rule that determines whether a table candidate for the Semantic Property contains column candidates of a specified Column Semantic Property.

25. The method of claim 18, wherein the Semantic Rules comprise one or more rules selected from:
a rule that checks for column name matches,
a rule that checks for column names that contain a specified string,
a rule that checks a datatype of each column,
a rule that determines whether a number of distinct values in a column is greater-than or less-than a user-specified value,
a rule that determines whether a number of distinct values in a column is many or few,
a rule that checks whether a column is a primary key, and
a rule that checks whether a column is a foreign key.

26. The method of claim 18, wherein the Semantic Engine performs one or more functions selected from:
accessing the database metadata,
accessing the Semantic Properties and Semantic Rules,
executing the Semantic Algorithm that performs the Semantic Rules to apply the Semantic Properties to the database tables and columns using the database metadata,
updating the table and column properties found in the database metadata to reflect the Semantic Properties assigned to the database tables and columns by the Semantic Rules, and
generating semantic reasoning information.

27. The method of claim 26, wherein the Semantic Algorithm executed by the Semantic Engine loops through table and column properties found in the database metadata, and performs the Semantic Rules, which results in assignment of the Semantic Properties to the database tables and columns.

28. The method of claim 18, wherein the Semantic Algorithm performs one or more functions selected from:
performing all Column Semantic Rules on each database column, and then assigning the Column Semantic Property to the best candidates,
performing simple Table Semantic Rules on each database table to generating resulting tables,
filtering the resulting table candidates to remove noise tables,
performing complex Table Semantic Rules on each database table remaining after the noise tables have been filtered to identify best candidate tables, and then assigning the Table Semantic Property to the best candidates, and
generating semantic reasoning information resulting from the Semantic Rules.

29. The method of claim 28, wherein the simple Table Semantic Rules include name tests, table name and column substring tests, and row count and column count tests.

30. The method of claim 28, wherein the complex Table Semantic Rules include: 1 to many, and many to 1 with the optional join cardinality tests, and tests to determine whether a table candidate contains a previously-assigned Column Semantic Property.

31. The method of claim 28, wherein the semantic reasoning information includes the Semantic Rule, the Semantic Property, and results of applying the Semantic Rule.

32. The method of claim 18, wherein the Semantic Algorithm is a scoring algorithm that assigns weights to one or more of the Semantic Rules, and then uses these weights to assign Semantic Properties to the database tables and columns.

33. The method of claim 32, wherein, in order for the Semantic Property to be assigned, a highest scoring candidate must reach a certain point threshold.

34. The method of claim 18, wherein assignment of a Semantic Property is based on a multiplicity value for the Semantic Property.
